(19) United States
(12) Patent Application Publication
(10) Pub. No.: US 2026/0005621 A1
(43) Pub. Date: Jan. 1, 2026

(54) Parallel resonant inverter and parallel-inverter control system

(71) Applicant: Huizhou ROYPOW Technology Co., Ltd., Huizhou (CN)

(72) Inventors: Jacobo Aguillon-Garcia, Huizhou (CN); Quanfu ZOU, Huizhou (CN)

(73) Assignee: Huizhou ROYPOW Technology Co., Ltd., Huizhou, GU (CN)

(21) Appl. No.: 19/094,738

(22) Filed: Mar. 28, 2025

(30) Foreign Application Priority Data
Jun. 26, 2024 (CN) 202410832285.9

(51) Int. Cl. H02M 7/48; H02M 1/00; H02M 1/44; H02M 3/337; H02M 7/5381

(52) U.S. Cl. CPC H02M 7/4815; H02M 1/007; H02M 1/44; H02M 3/3372; H02M 7/5381

(57) ABSTRACT

A parallel resonant inverter includes a first inductor, a first switch tube, a second switch tube, a parallel resonant module, a first isolation capacitor, and a second isolation capacitor. The first inductor, a drain of the first switch tube, a source of the first switch tube, and an external DC power supply are sequentially connected in series to form a first loop. The first inductor, the parallel resonant module, a drain of the second switch tube, a source of the second switch tube, and the external DC power supply are sequentially connected in series to form a second loop. The first inductor, the first isolation capacitor, an external load, the second isolation capacitor, the drain of the second switch tube, the source of the second switch tube, and the external DC power supply are sequentially connected in series to form a third loop.

### CROSS-REFERENCE TO RELATED APPLICATION

This application claims priority to Chinese Patent Application No. 202410832285.9, filed on Jun. 26, 2024, the disclosure of which is hereby incorporated by reference in its entirety. No new matter has been introduced.

### TECHNICAL FIELD

The disclosure relates to the technical field of inverters, and in particular to a parallel resonant inverter and a parallel-inverter control system.

### BACKGROUND

A sine wave inverter is a type of inverter that converts DC power into AC power. In turn, the inverter can be used to drive various electronic apparatuses and household appliances, to bring great convenience to the lives of people.

Current sine wave inverters contain many electronic components for converting DC power into AC power, resulting in a large electrical-energy loss and a low conversion efficiency of voltage during a conversion of DC power. In addition, the sine wave inverters are expensive, occupy a large space, and have low reliability.

### SUMMARY

A parallel resonant inverter and a parallel-inverter control system are provided according to the disclosure, which are used to solve problems in some implementations that an inverter has a large electrical-energy loss and low conversion efficiency of voltage during a conversion for DC power, and a sine wave inverter has a high cost, large space occupation and low reliability.

In a first aspect, a parallel resonant inverter is provided according to the disclosure, comprising a first inductor, a first switch tube, a second switch tube, a parallel resonant module, a first isolation capacitor, and a second isolation capacitor; wherein, the first inductor, a drain of the first switch tube, a source of the first switch tube, and an external DC power are sequentially connected in series to form a first loop; the first inductor, the parallel resonant module, a drain of the second switch tube, a source of the second switch tube, and the external DC power are sequentially connected in series to form a second loop; the first inductor, the first isolation capacitor, an external load, the second isolation capacitor, the drain of the second switch tube, the source of the second switch tube, and the external DC power are sequentially connected in series to form a third loop;
wherein, in each control period, the first switch tube and the second switch tube are turned on in turn;
in a condition that the drain of the first switch tube is disconnected from the source of the first switch tube, and the drain of the second switch tube and the source of the second switch tube are turned on; the first loop is disconnected and the second loop is turned on, and thus the external DC power outputs a DC voltage to the first inductor and the parallel resonant module, to make the first inductor and the parallel resonant module store an electrical energy;
in a condition that the drain of the second switch tube is disconnected from the source of the second switch tube, and the drain of the first switch tube and the source of the first switch tube are turned on; the first loop is turned on and the second loop is disconnected, the external DC power outputs the DC voltage to the first inductor, to make the first inductor store an electrical energy; wherein the parallel resonant module outputs an AC voltage through the first isolation capacitor and the second isolation capacitor, and supplies a power to the external load based on the AC voltage.

In a possible implementation, when the first loop is disconnected and the second loop is turned on, the parallel resonant inverter is in a first working state; when the first loop is turned on and the second loop is disconnected, the parallel resonant inverter is in a second working state;

In which, a switching frequency between the first working state and the second working state satisfies fₛ<f₀, where fₛ represents the switching frequency between the first working state and the second working state; f₀ represents a resonance frequency of the parallel resonant module.

In a possible implementation, when the first loop is disconnected and the second loop is turned on, the parallel resonant inverter is in a first working state; when the first loop is turned on and the second loop is disconnected, the parallel resonant inverter is in a second working state;

In which, a switching frequency between the first working state and the second working state satisfies fₛ=f₀, where fₛ represents the switching frequency between the first working state and the second working state; f₀ represents a resonance frequency of the parallel resonant module.

In a possible implementation, when the first loop is disconnected and the second loop is turned on, the parallel resonant inverter is in a first working state; when the first loop is turned on and the second loop is disconnected, the parallel resonant inverter is in a second working state;

In which, a switching frequency between the first working state and the second working state satisfies fₛ>f₀, where fₛ represents the switching frequency between the first working state and the second working state; f₀ represents a resonance frequency of the parallel resonant module.

In a possible implementation, the parallel resonant module comprises a resonant capacitor and a resonant inductor connected in parallel.

In a possible implementation, a resonance frequency f₀ of the parallel resonant module satisfies a condition that

$${f}_{0} = \frac{1}{2 π \sqrt{{L}_{r} {C}_{r}}} ,$$

where Cᵣ a capacitance value of the resonant capacitor and Lᵣ is an inductance value of the resonant inductor.

In a possible implementation, the parallel resonant inverter comprises a rectifier, wherein the rectifier comprises a first input terminal, a first output terminal, a second input terminal, and a second output terminal; wherein the first isolation capacitor is electrically connected to the first input terminal, the first output terminal being connected to an input terminal of the external load, the second input terminal being connected to an output terminal of the external load, the second output terminal being electrically connected to the second isolation capacitor.

In a possible implementation, the first switch tube is a first transistor, and the second switch tube is a second transistor.

In a possible implementation manner, the external load is a household electronic apparatus.

In a second aspect, a parallel-inverter control system is also provided according to an embodiment of the disclosure, including a central controller and the parallel resonant inverter provided in the first aspect of the disclosure. The central controller is electrically connected a gate of the first switch tube and a gate of the second switch tube respectively, and is used to control the first switch tube and the second switch tube to be turned on in turn in each control period.

A parallel resonant inverter and a parallel-inverter control system are provided according to the disclosure. In a condition that the drain of the first switch tube is disconnected from the source of the first switch tube, and the drain of the second switch tube and the source of the second switch tube are turned on; the first loop is disconnected and the second loop is turned on, and thus the external DC power outputs a DC voltage to the first inductor and the parallel resonant module, to make the first inductor and the parallel resonant module store an electrical energy. Since the second loop only includes the first inductor and the parallel resonant module after the second switch tube is turned on, an energy loss of DC may be small, such that an internal resistance and electrical-energy loss may be reduced, the voltage conversion efficiency is high, a power density is high, a cost of the parallel resonant inverter is low, and a space occupied is small. In addition, due to a small energy loss, various components in the parallel resonant inverter have long service life and high reliability. Fewer components in the parallel resonant inverter means fewer potential failure points, which further improves the reliability. An output voltage is a pure sine wave, which can reduce an electrical noise and avoid an interfering with a performance of electronic apparatuses. The external load, driven by the output voltage of the pure sine wave, runs more efficiently, which can further reduce an energy consumption.

In addition, in a condition that the drain of the second switch tube is disconnected from the source of the second switch tube, and the drain of the first switch tube and the source of the first switch tube are turned on; the first loop is turned on and the second loop is disconnected, the external DC power outputs the DC voltage to the first inductor, to make the first inductor store an electrical energy; wherein the parallel resonant module outputs an AC voltage through the first isolation capacitor and the second isolation capacitor, and supplies a power to the external load based on the AC voltage. Since only the first inductor is included in the first loop after the first switch tube is turned on, such that a DC electrical-energy loss can be further made small, the voltage conversion efficiency is high. The parallel resonant inverter has less cost, less occupied space, and high reliability.

### BRIEF DESCRIPTION OF DRAWINGS

In order to more clearly illustrate the technical solutions in the embodiments of the disclosure or the technical solutions in some implementations, the accompanying drawings required for use in the description of the embodiments or for use in the description of the technical solutions in some implementations will be briefly introduced in the following. Obviously, the accompanying drawings described below are some embodiments of the disclosure. For those skilled in the art, other accompanying drawings can be obtained based on these drawings without creative work.

FIG. 1 is a circuit diagram of a parallel resonant inverter according to an embodiment of the disclosure;

FIG. 2 is a waveform diagram of operating parameters of various components of the parallel resonant inverter according to an embodiment of the disclosure when a switching frequency between a first working state and a second working state satisfies fₛ<f₀;

FIG. 3 is a waveform diagram of the operating parameters of various components of the parallel resonant inverter according to an embodiment of the disclosure when the switching frequency between the first working state and the second working state satisfies fₛ=f₀;

FIG. 4 is a waveform diagram of the operating parameters of various components of the parallel resonant inverter according to an embodiment of the disclosure when the switching frequency between the first working state and the second working state satisfies fₛ>f₀;

FIG. 5 is a schematic diagram for characterizing an efficiency of the parallel resonant inverter according to an embodiment of the disclosure.

### DETAILED DESCRIPTION

Hereinafter, embodiments of the disclosure will be described with reference to the accompanying drawings. It should be understood, however, that these descriptions are illustrative only and are not intended to limit a scope of the disclosure. Furthermore, in the following description, descriptions of well-known structures and technologies are omitted to avoid unnecessarily obscuring concepts in the disclosure.

The accompanying drawings show various structural schematic diagrams according to embodiments of the disclosure. The accompanying drawings are not drawn to scale. Some details may be exaggerated, and some details may be omitted for clarity of presentation. Shapes of various regions and layers shown in the accompanying drawings and relative sizes and positions of the various regions and layers are merely illustrative and may deviate in practice due to manufacturing tolerances or technical limitations. Those skilled in the art may also design regions or layers with different shapes, sizes and relative positions according to actual needs.

In the context of the disclosure, when a layer or element is referred to as being “on” another layer or element, the layer or element can be directly on another layer or element or an intervening layer or element may be present therebetween. In addition, if a layer or element is “on” another layer or element in an orientation, then when the orientation is reversed, the layer or element may be “below” another layer or element.

The following is a detailed description of the technical solution of the disclosure and how the technical solution of the disclosure solves the above-mentioned technical problems according to the embodiments of the disclosure. The following embodiments may be combined with each other, and the same or similar concepts or processes may not be described in detail in some embodiments. The embodiments of the disclosure will be described below in conjunction with the accompanying drawings.

As shown in FIG. 1, a parallel resonant inverter is provided according to an embodiment of the disclosure, including a first inductor 13, a first switch tube 14, a second switch tube 15, a parallel resonant module 12, a first isolation capacitor 18, and a second isolation capacitor 19. The first inductor 13, a drain of the first switch tube 14, a source of the first switch tube 14, and an external DC power supply 10 are sequentially connected in series to form a first loop. The first inductor 13, the parallel resonant module 12, a drain of the second switch tube 15, a source of the second switch tube 15, and the external DC power supply 10 are sequentially connected in series to form a second loop. The first inductor 13, the first isolation capacitor 18, an external load 22, the second isolation capacitor 19, the drain of the second switch tube 15, the source of the second switch tube 15, and the external DC power supply 10 are sequentially connected in series to form a third loop. In each control period, the first switch tube 14 and the second switch tube 15 are respectively turned on in turn.

Exemplarily, the first switch tube 14 may be but not limited to a first transistor. The second switch tube 15 may be but not limited to a second transistor. The external load 22 may be but not limited to household electronic apparatus (such as a television, a refrigerator, and an air conditioner, and the like). The external load 22 may also be an outdoor electronic apparatus or an in-vehicle electronic apparatus and the like.

In a condition that the drain of the first switch tube 14 is disconnected from the source of the first switch tube 14, and the drain of the second switch tube 15 and the source of the second switch tube 15 are turned on, the first loop is disconnected and the second loop is turned on, and thus the external DC power supply 10 outputs a DC voltage to the first inductor 13 and the parallel resonant module 12, to make the first inductor 13 and the parallel resonant module 12 store an electrical energy.

In a condition that the drain of the second switch tube 15 is disconnected from the source of the second switch tube 15, and the drain of the first switch tube 14 and the source of the first switch tube 14 are turned on. The first loop is turned on and the second loop is disconnected, and thus the external DC power supply 10 outputs the DC voltage to the first inductor 13, to make the first inductor 13 store an electrical energy. The parallel resonant module 12 outputs an AC voltage through the first isolation capacitor 18 and the second isolation capacitor 19, and supplies a power to the external load 22 based on the AC voltage.

Exemplarily, the parallel resonant module 12 includes a resonant capacitor 16 and a resonant inductor 17 connected in parallel. A resonance frequency f₀ of the parallel resonant module 12 satisfies a condition that

$${f}_{0} = \frac{1}{2 π \sqrt{{L}_{r} {C}_{r}}} ,$$

where Cᵣ represents a capacitance value of the resonant capacitor 16 and Lᵣ is an inductance value of the resonant inductor 17. In addition, a quality factor of the parallel resonant module 12 satisfies

$${Q}_{L} = {ω}_{0} {C}_{r} {R}_{0} = \frac{{R}_{0}}{{ω}_{0} {L}_{r}} ,$$

where R₀ represents an impedance of an output load, Cᵣ represents a capacitance of the resonant capacitor 16, Lᵣ represents an inductance of the resonant inductor 17, Q_{L} represents a quality factor of the parallel resonant module 12, and ω₀ represents a natural resonant frequency of the parallel resonant module 12 that is represented by a radian.

In some embodiments, working modes of the parallel resonant inverter include but are not limited to the following three working modes: a first working mode, a second working mode and a third working mode.

In the first working mode, when the first loop is disconnected and the second loop is turned on, the parallel resonant inverter is in a first working state; and when the first loop is turned on and the second loop is disconnected, the parallel resonant inverter is in a second working state.

A switching frequency between the first working state and the second working state satisfies fₛ<f₀, where fₛ represents the switching frequency between the first working state and the second working state; f₀ represents a resonance frequency of the parallel resonant module 12.

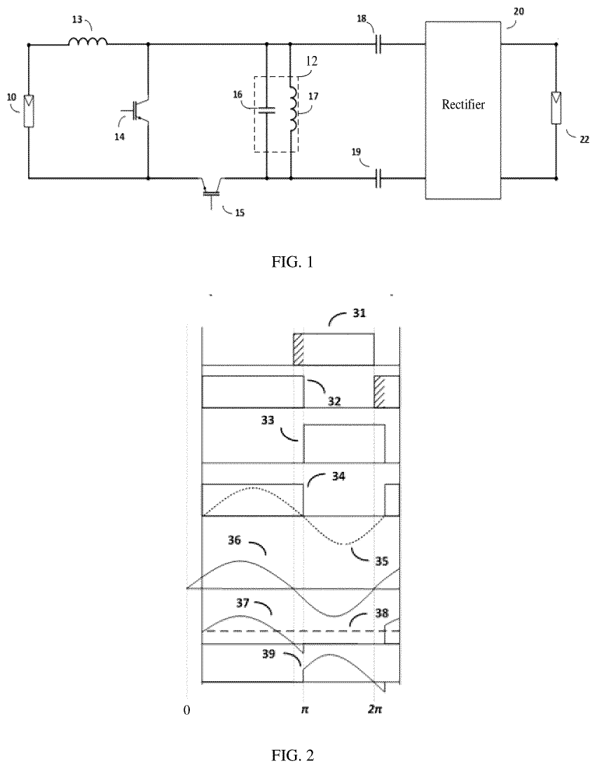

When fₛ<f₀, a voltage waveform of the parallel resonant module 12 may be made to precede a basic component of a current waveform passing through the parallel resonant module 12. A phase angle between the voltage waveform of the parallel resonant module 12 and the basic component of the current waveform passing through the parallel resonant module 12 is v. At this time, an operating voltage and/or operating current of each component in the parallel resonant inverter are shown in FIG. 2. In FIG. 2, a signal wave 31 is a switching-voltage signal waveform of the first switch tube 14. A signal wave 32 is a switching-voltage signal waveform of the second switch tube 15. A signal wave 33 is a current waveform of the first switch tube 14. A signal wave 34 is a current waveform of the second switch tube 15. A signal wave 35 is a waveform of a fundamental frequency portion of a current input to the second switch tube 15. A signal wave 36 is a voltage waveform of the parallel resonant module 12. It may be understood that the voltage waveform of the parallel resonant module 12 is a sine waveform sin(ωt). A signal wave 37 is a voltage waveform of the first switch tube 14. A signal wave 38 is an average voltage waveform of the voltage waveform of the first switch tube 14. A signal wave 39 is a voltage waveform of the second switch tube 15.

When the switching frequency between the first working state and the second working state satisfies fₛ<f₀, if the switching-voltage signal waveform 31 of the first switch tube 14 drops from a high level to a low level, that is, when ωt=0, the first switch tube 14 is disconnected and the second switch tube 15 is turned on. When 0<ωt<π, the voltage waveform 37 of the first switch tube 14 is positive. The first switch tube 14 remains disconnected and the second switch tube 15 remains turned on. When the voltage 37 of the first switch tube 14 is lower than a saturation voltage of the first switch tube 14, the first switch tube 14 may be in a turned-on state or a disconnected state without any loss. It may be understood that since a sinusoidal voltage on the parallel resonant module 12, and the first switch tube 14 prevent a current from flowing, and thus a loss of turning on and disconnecting the first switch tube 14 can be made zero. When ωt=π, the switching-voltage signal waveform of the second switch tube 15 is dropped from a high level to a low level, and the second switch tube 15 is disconnected.

Further, when π<ωt≤2π, the first switch tube 14 starts to be turned on. With a disconnecting of the second switch tube 15 and a turning on of the first switch tube 14, the voltage waveform (sine wave voltage) of the parallel resonant module 12 may be generated. The voltage waveform of the parallel resonant module 12 may be coupled towards the external load 22 through the first isolation capacitor 18 and the second isolation capacitor 19.

In the second working mode, when the first loop is disconnected and the second loop is turned on, the parallel resonant inverter is in a first working state; and when the first loop is turned on and the second loop is disconnected, the parallel resonant inverter is in a second working state.

A switching frequency between the first working state and the second working state satisfies fₛ=f₀, where fₛ represents the switching frequency between the first working state and the second working state; f₀ represents a resonance frequency of the parallel resonant module 12.

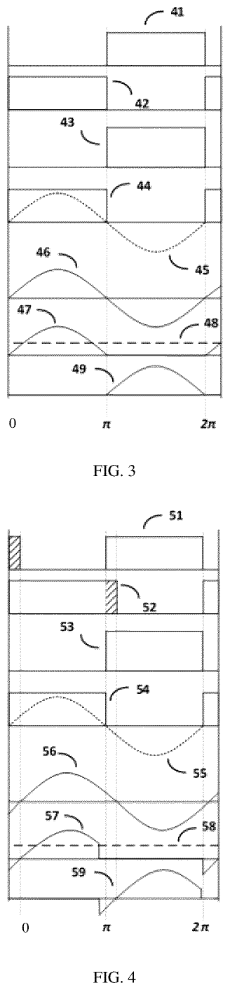

At this time, an operating voltage and/or operating current of each component in the parallel resonant inverter are as shown in FIG. 3. In FIG. 3, a signal wave 41 is a switching-voltage signal waveform of the first switch tube 14. A signal wave 42 is a switching-voltage signal waveform of the second switch tube 15. A signal wave 43 is a current waveform of the first switch tube 14. A signal wave 44 is a current waveform of the second switch tube 15. A signal wave 45 is a waveform of a fundamental frequency portion of a current input to the second switch tube 15. A signal wave 46 is a voltage waveform of the parallel resonant module 12. It may be understood that the voltage waveform of the parallel resonant module 12 is a sine waveform sin(ωt). A signal wave 47 is a voltage waveform of the first switch tube 14. A signal wave 48 is an average voltage waveform of the voltage waveform of the first switch tube 14. A signal wave 49 is a voltage waveform of the second switch tube 15.

It should be noted that, a working principle of the parallel resonant inverter in a condition that fₛ=f₀ is partially identical to that in a condition that fₛ<f₀. The difference in these working principles is that, in a condition that fₛ=f₀, the parallel resonant inverter behaves as a resistive load, as still shown in FIG. 3. The parallel resonant inverter behaving as the resistive load means that the waveform of the fundamental frequency portion of the current input to the second switch tube 15, i.e. the signal wave 45, has the same phase as the voltage waveform of the parallel resonant module 12, i.e. the signal wave 46. When fₛ=f₀, if a voltage across the first switch tube 14 or a voltage across the second switch tube 15 is zero, the first switch tube 14 or the second switch tube 15 may be controlled to be turned on or off, which is called a zero voltage switch. When the voltage across the first switch tube 14 or second switch tube 15 is equal to a resonant voltage of the parallel resonant inverter, the first switch tube 14 or the second switch tube 15 has a zero loss. In this way, a voltage conversion efficiency of the parallel resonant inverter may be maximized.

In the third working mode: when the first loop is disconnected and the second loop is turned on, the parallel resonant inverter is in a first working state; and when the first loop is turned on and the second loop is disconnected, the parallel resonant inverter is in a second working state. A switching frequency between the first working state and the second working state satisfies fₛ>f₀, where fₛ represents the switching frequency between the first working state and the second working state; f₀ represents a resonance frequency of the parallel resonant module 12.

In a condition that fₛ>f₀, the parallel resonant inverter behaves as a capacitive load. At this time, the voltage waveform of the parallel resonant module 12 may be made to lag behind the basic component of the current waveform passing through the parallel resonant module 12. A phase angle between the voltage waveform of the parallel resonant module 12 and the basic component of the current waveform passing through the parallel resonant module 12 is Ψ.

At this time, an operating voltage and/or operating current of each component in the parallel resonant inverter are as shown in FIG. 4. In FIG. 4, a signal wave 51 is a switching-voltage signal waveform of the first switch tube 14. A signal wave 52 is a switching-voltage signal waveform of the second switch tube 15. A signal wave 53 is a current waveform of the first switch tube 14. A signal wave 54 is a current waveform of the second switch tube 15. A signal wave 55 is a waveform of a fundamental frequency portion of a current input to the second switch tube 15. A signal wave 56 is a voltage waveform of the parallel resonant module 12. It may be understood that the voltage waveform of the parallel resonant module 12 is a sine waveform sin(ωt). A signal wave 57 is a voltage waveform of the first switch tube 14. A signal wave 58 is an average voltage waveform of the voltage waveform of the first switch tube 14. A signal wave 59 is a voltage waveform of the second switch tube 15.

During the voltage waveform 56 of the parallel resonant module 12 is in a negative voltage phase, the first switch tube 14 must be turned off, as shown by a shaded area in FIG. 4. When ωt=π, the switching-voltage signal waveform 51 of the first switch tube 14 is switched from a low level to a high level, and the first switch tube 14 is triggered to be turned on. When π<ωt≤2π, the first switch tube 14 remains in a turned-on state until the next period begins.

In addition, still as shown in FIG. 1, the parallel resonant inverter includes a rectifier 20. The rectifier 20 includes a first input terminal, a first output terminal, a second input terminal, and a second output terminal. The first isolation capacitor 18 is electrically connected to the first input terminal. The first output terminal is connected to an input terminal of the external load 22. The second input terminal is connected to an output terminal of the external load 22. The second output terminal is electrically connected to the second isolation capacitor 19.

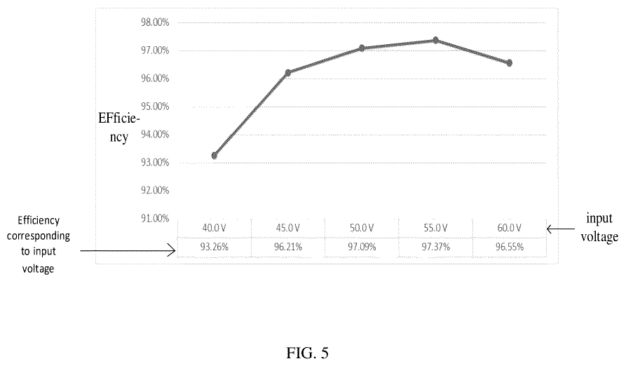

Exemplarily, an efficiency of the parallel resonant inverter according to some embodiments of the disclosure is shown in FIG. 5, if a power level of the parallel resonant inverter is 3.6 KW, an input voltage Vᵢₙ of the external DC power supply 10 is any voltage value in a range of 40 V-60 V, an output voltage V_{o_nom} of the parallel resonant inverter to the external load 22 is 405 V, and a drain-source on-resistance RDS_{ON} of the parallel resonant inverter is 10 mΩ.

In addition, a parallel-inverter control system is also provided according to an embodiment of the disclosure, including a central controller and the parallel resonant inverter provided in the above embodiments of the disclosure. The central controller is electrically connected a gate of the first switch tube 14 and a gate of the second switch tube 15 respectively, and is used to control the first switch tube 14 and the second switch tube 15 to be respectively turned on in turn in each control period.

In conclusion, with a parallel resonant inverter and a parallel-inverter control system provided according to an embodiment of the disclosure, in a condition that the drain of the first switch tube 14 is disconnected from the source of the first switch tube 14, and the drain of the second switch tube 15 and the source of the second switch tube 15 are turned on; the first loop is disconnected and the second loop is turned on, and thus the external DC power supply 10 outputs a DC voltage to the first inductor 13 and the parallel resonant module 12, to make the first inductor 13 and the parallel resonant module 12 store an electrical energy. Since the second loop only includes the first inductor 13 and the parallel resonant module 12 after the second switch tube 15 is turned on, an electrical-energy loss of DC power supply may be small, such that an internal resistance and electrical-energy loss may be reduced, the voltage conversion efficiency is high, a power density is high, a cost of the parallel resonant inverter is low, and a space occupied is small. In addition, due to a small electrical-energy loss, various components in the parallel resonant inverter have long service life and high reliability. Fewer components in the parallel resonant inverter mean fewer potential failure points, which further improves the reliability. An output voltage is a pure sine wave, which can reduce an electrical noise and avoid an interference with a performance of electronic apparatuses. The external load 22, driven by the output voltage of the pure sine wave, runs more efficiently, thereby further reducing an energy consumption.

In addition, in a condition that the drain of the second switch tube 15 is disconnected from the source of the second switch tube 15, and the drain of the first switch tube 14 and the source of the first switch tube 14 are turned on. The first loop is turned on and the second loop is disconnected, and thus the external DC power supply 10 outputs the DC voltage to the first inductor 13, to make the first inductor 13 store an electrical energy. The parallel resonant module 12 outputs an AC voltage through the first isolation capacitor 18 and the second isolation capacitor 19, and supplies a power to the external load 22 based on the AC voltage. Since only the first inductor 13 is included in the first loop after the first switch tube 14 is turned on, such that a DC electrical-energy loss can be further made small, the voltage conversion efficiency is high. The parallel resonant inverter has less cost, less occupied space, and high reliability.

In the above description, the technical details such as compositions of each layer are not explained in detail. However, those skilled in the art should understand that various technical means may be used to form layers, regions and so on with desired shapes. Further, in order to form a same structure, those skilled in the art may also design a method that is not completely the same as the method described above. Furthermore, although various embodiments have been described above separately, this does not mean that measures in the various embodiments cannot be advantageously used in combination.

Although preferred embodiments of the disclosure have been described, additional changes and modifications may be made to these embodiments once those skilled in the art are aware of the basic inventive concepts. Therefore, it is intended that the appended claims are interpreted as including the preferred embodiment as well as all changes and modifications that fall within the scope sought by the disclosure.

Obviously, those skilled in the art can make various changes and modifications to the disclosure without departing from the spirit and scope of the disclosure. Thus, if these modifications and variations of the disclosure fall within the scope of the claims of the disclosure and equivalent technologies thereof, the disclosure is also intended to include these modifications and variations. CLAIMS

1. A parallel resonant inverter, comprising a first inductor, a first switch tube, a second switch tube, a parallel resonant module, a first isolation capacitor, and a second isolation capacitor, wherein the first inductor, a drain of the first switch tube, a source of the first switch tube, and an external DC power supply are sequentially connected in series to form a first loop; the first inductor, the parallel resonant module, a drain of the second switch tube, a source of the second switch tube, and the external DC power supply are sequentially connected in series to form a second loop; the first inductor, the first isolation capacitor, an external load, the second isolation capacitor, the drain of the second switch tube, the source of the second switch tube, and the external DC power supply are sequentially connected in series to form a third loop;
wherein, in each control period, the first switch tube and the second switch tube are turned on in turn;
in a condition that the drain of the first switch tube is disconnected from the source of the first switch tube, and the drain of the second switch tube and the source of the second switch tube are turned on, the first loop is disconnected and the second loop is turned on, and thus the external DC power supply outputs a DC voltage to the first inductor and the parallel resonant module, to make the first inductor and the parallel resonant module to store an electrical energy;
in a condition that the drain of the second switch tube is disconnected from the source of the second switch tube, and the drain of the first switch tube and the source of the first switch tube are turned on, the first loop is turned on and the second loop is disconnected, and thus the external DC power supply outputs the DC voltage to the first inductor, to make the first inductor to store the electrical energy; and wherein the parallel resonant module outputs an AC voltage through the first isolation capacitor and the second isolation capacitor, and supplies a power to the external load based on the AC voltage; when the first loop is disconnected and the second loop is turned on, the parallel resonant inverter is in a first working state; and when the first loop is turned on and the second loop is disconnected, the parallel resonant inverter is in a second working state.

2. The parallel resonant inverter according to claim 1, wherein
a switching frequency between the first working state and the second working state satisfies fₛ<f₀, where fₛ represents the switching frequency between the first working state and the second working state; f₀ represents a resonance frequency of the parallel resonant module.

3. The parallel resonant inverter according to claim 1, wherein
a switching frequency between the first working state and the second working state satisfies fₛ=f₀, where fₛ represents the switching frequency between the first working state and the second working state; f₀ represents a resonance frequency of the parallel resonant module.

4. The parallel resonant inverter according to claim 1, wherein a switching frequency between the first working state and the second working state satisfies fₛ>f₀, where fₛ represents the switching frequency between the first working state and the second working state; f₀ represents a resonance frequency of the parallel resonant module.

5. The parallel resonant inverter according to claim 2, wherein the parallel resonant module comprises a resonant capacitor and a resonant inductor connected in parallel.

6. The parallel resonant inverter according to claim 3, wherein the parallel resonant module comprises a resonant capacitor and a resonant inductor connected in parallel.

7. The parallel resonant inverter according to claim 4, wherein the parallel resonant module comprises a resonant capacitor and a resonant inductor connected in parallel.

8. The parallel resonant inverter according to claim 5, wherein a resonance frequency f₀ of the parallel resonant module satisfies a condition that
$${f}_{0} = \frac{1}{2 π \sqrt{{L}_{r} {C}_{r}}} ,$$
where Cᵣ is a capacitance value of the resonant capacitor and Lᵣ is an inductance value of the resonant inductor.

9. The parallel resonant inverter according to claim 1, wherein the parallel resonant inverter comprises a rectifier, wherein the rectifier comprises a first input terminal, a first output terminal, a second input terminal, and a second output terminal; wherein the first isolation capacitor is electrically connected to the first input terminal, the first output terminal being connected to an input terminal of the external load, the second input terminal being connected to an output terminal of the external load, the second output terminal being electrically connected to the second isolation capacitor.

10. The parallel resonant inverter according to claim 1, wherein, the first switch tube is a first transistor, and the second switch tube is a second transistor.

11. The parallel resonant inverter according to claim 1, wherein the external load is a household electronic apparatus.

12. A parallel-inverter control system, comprising a central controller and the parallel resonant inverter according to claim 1, wherein the central controller is electrically connected to a gate of the first switch tube and a gate of the second switch tube respectively, and is used to control the first switch tube and the second switch tube to be turned on in turn in each control period.
